(19) United States
(12) Patent Application Publication
(10) Pub. No.: US 2003/0174503 A1
(43) Pub. Date: Sep. 18, 2003

(54) Supporting frame for work light

(75) Inventor: Ching Yueh, Taipei City (TW)

Correspondence Address: BACON & THOMAS, PLLC, 625 SLATERS LANE, FOURTH FLOOR, ALEXANDRIA, VA, 22314

(73) Assignee: Test Rite International Company, Ltd., Taipei (TW)

(21) Appl. No.: 10/145,710

(22) Filed: May 16, 2002

(30) Foreign Application Priority Data
Mar. 12, 2002 (CN) 02 2 07627.1

(51) Int. Cl. F21S 8/08

(52) U.S. Cl. 362/413; 362/414; 362/250

(57) ABSTRACT

A supporting frame for work light, used in work light installation, comprising a set of extension rods, a fixating mechanism and a supporting frame; the supporting frame is pivotally jointed to the extension rods, whereon the fixating mechanism is used for fixating the state of extension; the fixating mechanism, installed at the junction of the extension rod, includes a notched main body and a movable rod; the movable rod is to be operated with single action, so as to control the state of tightness or looseness of the fixating mechanism, and further fastens the fixating mechanism or release the state of extension of the extension rod.

### BACKGROUND OF THE INVENTION

### FIELD OF THE INVENTION

The invention relates to a fixating mechanism for supporting frame for work light, more particularly, a fixating mechanism that, used for supporting frame for work light adjustable regarding heights, secures the height of the supporting frame through a single movable rod to control the state of tightness and looseness.

### DESCRIPTION OF THE RELATED ART

The Chinese utility model patent No. 01200178.3 applied by the Inventor of the invention discloses a supporting frame for work light that comprises a light base whereon lights are installed; an extension rod, jointing with the light base, that is fastened by the fixating mechanism to secure the state of extension, thus fixating the height of the supporting frame for work light; a supporting frame, pivotally jointed onto the extension rod, so as to support the extension rod and keep the supporting frame for work light standing on the ground. The fixating mechanism is of a ring structure having notches. Furthermore, two end portions are formed at the notched portion of the fixating mechanism, with a screw piercing through both; one end of such screw pierces through the end portion of the ring structure and pivotally joints a movable rod, and the other end of the screw then pierces through the other end portion of the ring structure; and then a screw nut is used for propping against the end portion by rotating in. The movable rod contains cam structure, thus when the movable rod is working, the cam structure thereof is to force the end portion to be closer to the other end portion, further tightening together both end portions of the ring structure. Nonetheless, the fixating mechanism of the prior art needs a screw hole and screw nut to correspond to the ring structure, and then the cam structure of the movable rod is used for tightening together the two end portions of the movable, thus increasing the production cost and the manufacturing processes.

### SUMMARY OF THE INVENTION

The primary object of the invention is to provide a fixating mechanism, used for supporting frame for work light adjustable regarding heights, that secures the height of the supporting frame through a single movable rod to control the state of tightness and looseness.

The supporting frame of the work light that achieves the foregoing objects is used for installing work lights, comprising a set of extension rods, a fixating mechanism and a supporting frame; the supporting frame is to be pivotally jointed to the extension rod, which is to be secured by the fixating mechanism to fixate the state of extension; the fixating mechanism, installed at the junction of the extension rod, includes a notched main body and a movable rod; the movable rod can be operated through single action to control the state of tightness or looseness of the fixating mechanism, and further enables the fixating mechanism to secure or release the state of extension of the extension rod.

The extension rod includes a first rod and a second rod, and the junction between the first and second rod is installed with the fixating mechanism to control the state of extension of the two rods.

The main body contains round holes having the same axis but different inner diameters; such round holes include a first piercing hole and a second piercing hole, with a protruding portion extended respectively from the first and second piercing holes.

The first piercing hole is used for being pierced by an extension rod.

The second piercing hole is used for being pierced by another extension rod.

The notched groove of the main body is formed by the two protruding portions of the first piercing hole and the second piercing hole.

The second piercing hole is to extend upwards to be installed with a concave ring, and on one side of the concave ring a plurality of protruding ribs are formed.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 shows a front view of the supporting frame for work light of the invention;

FIG. 2 shows a top plan view of the fixating mechanism of the supporting frame for work light of the invention;

FIG. 3 shows a sectional view from the X-X line in FIG. 2;

FIG. 4 shows a side view of the supporting frame for work light of the invention;

FIG. 5 shows a sectional view from the Y-Y line in FIG. 4;

FIG. 6 shows a sectional view of the fixating mechanism coordinating with the extension rod from the X-X line in FIG. 2;

FIG. 7 shows a sectional view of the fixating mechanism coordinating with the extension rod having state of tightness from the Y-Y line in FIG. 4;

FIG. 8 shows a sectional view of the fixating mechanism coordinating with the extension rod having state of looseness from the Y-Y line in FIG. 4; and

FIG. 9 shows another embodiment of the invention, displaying a sectional view of the fixating mechanism coordinating with the extension rod from the X-X line in FIG. 2.

### DETAILED DESCRIPTION OF THE PREFERRED EMBODIMENT

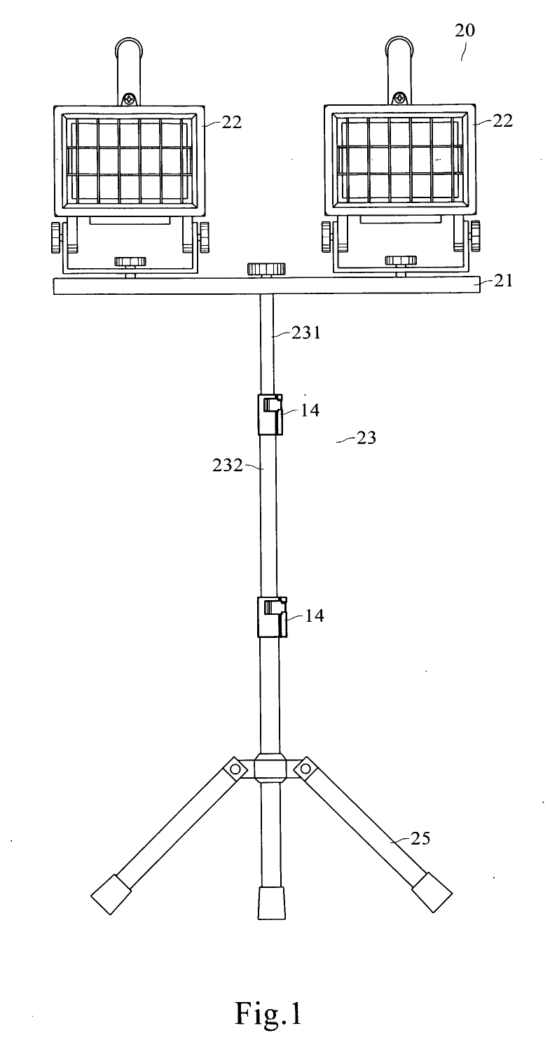

Please refer to FIG. 1 first, which shows a front view of the supporting frame for work light of the invention. The supporting frame 10 for work light of the invention comprises a light base 11, whereon work lights 12 are installed; a set of extension rods 13, jointing with the light base 11, that is fastened by the fixating mechanism 14 to secure the state of extension, thus fixating the height of the supporting frame 10 for work light; a supporting frame 15, pivotally jointed onto the extension rods 13, so as to support the extension rods 13 and keep the supporting frame 10 for work light standing on the ground. The fixating mechanism 14 includes a movable rod 17, thus enabling the user to use single action to operate the movable rod 17 to control the state of tightness or looseness of the fixating mechanism 14, with which the state of extension of the extension rods 13 can be secured or released.

In the preferred embodiment of the invention, the extension rods 13 of the supporting frame 10 for work light includes a first rod 131 and a second rod 132, wherein the first rod 131 is to be jointed to the light base 11, as shown in FIG. 1; for example, a screw can be used for locking the light base 11 on one end of the first rod 131, whereas a set of supporting frame 15 can be pivotally jointed to the second rod 132, thus the extension rods 13 can be kept standing on the ground. The fixating mechanism 14 is then installed on the junction of the first rod 131 and the second rod 132 to secure the state of extension of the extension rods 13.

The fixating mechanism 14 embodied in the invention comprises a main body 16 and a movable rod 17, wherein the main body 16 includes round holes 160 having the same axis but different inner diameters, such round holes 160 can be divided into a first piercing hole 161 and a second piercing hole 162 for the extension rods 13 to pierce through, and two protruding portions 141 and 142 are respectively extended from the first piercing hole 161 and the second piercing hole 162, with a notched groove 18, used for jointing the movable rod 17, being formed by the two protruding portions 141 and 142; axial holes are included respectively by the protruding portions 141 and 142 to coordinate with the axial hole of the movable rod 17 having the cam structure 171, so as to be pivotally jointed together to form the fixating mechanism 14 of the supporting frame 10 for work light.

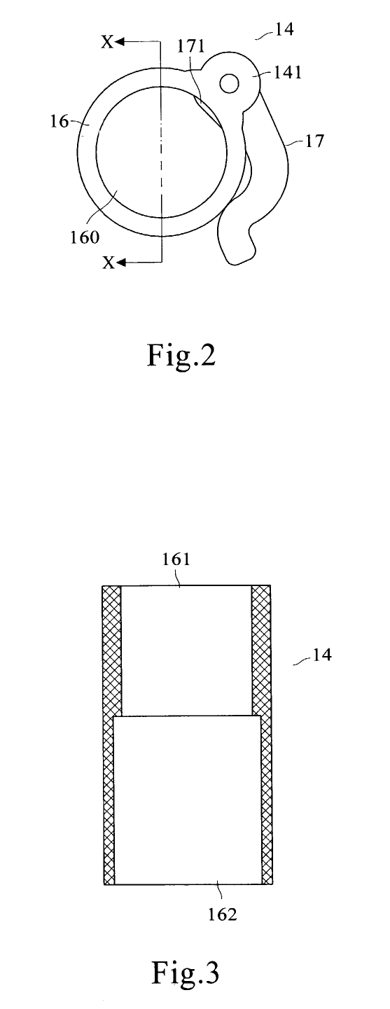

Please refer to FIG. 2 to FIG. 5, which show the fixating mechanism 14 of the embodiment of the invention. In the preferred embodiment of the invention, the round holes 160 of the main body 16 can be divided into a first piercing hole 161 and a second piercing hole 162, wherein the first piercing hole 161 is used for being pierced by the first rod 131, and the second piercing hole 162 is used for being pierced by the second rod 132; in addition, with the working of the movable rod 17 that contains the notched groove 18 formed by the protruding portion 141 of the first piercing hole 161 and the protruding portion 142 of the second piercing hole 162, the cam structure 171 installed in the movable rod 17 is able to control the state of looseness or tightness of the fixating mechanism 14, thus further enabling the fixating mechanism 14 to secure or release the extension state of the first rod 131. It is to be shown in FIG. 2 to FIG. 5 that, when the movable rod 17 is under state of drawing back, the movable rod 17 is to tightly lean on the outer side of the main body 16, thus causing the cam structure 171 of the notched groove 18 to protrude a bit portion into the first piercing hole 161, and then such bit protrusion of the cam structure 171 exactly props against the first rod 131 inside the first piercing hole 161, thus the extension state of the first rod 131 can be secured or released.

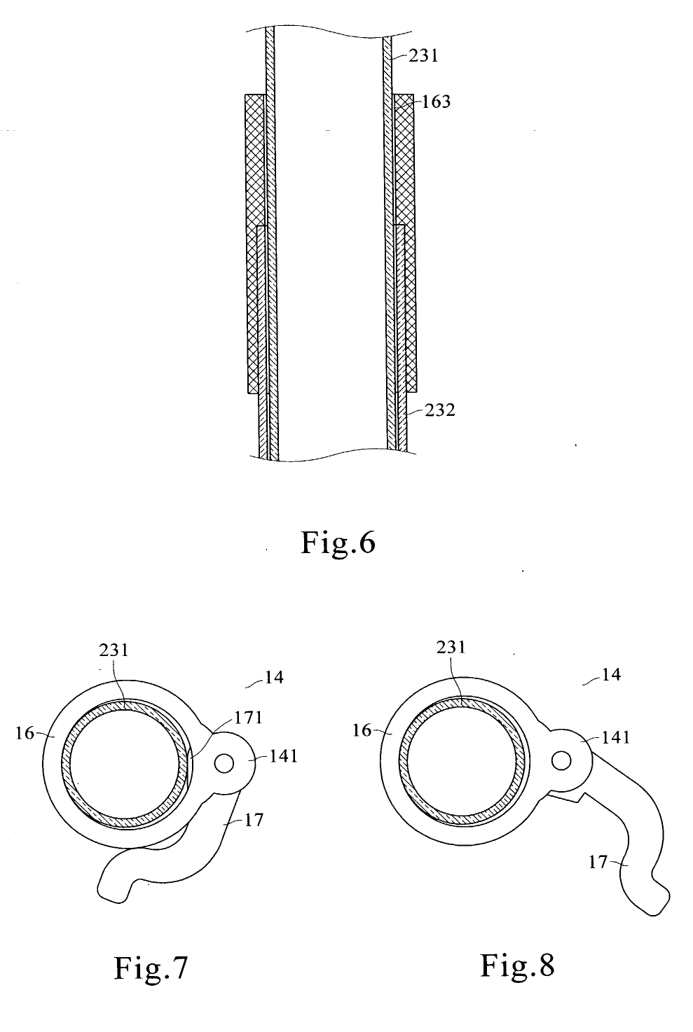

Please refer to FIG. 6, which shows a sectional view of the fixating mechanism coordinating with the extension rod from the X-X line in FIG. 2, wherein the second rod 132 is to tightly lean against the inside of the second piercing hole 162, and prop against the junction of the first piercing hole 161 and the second piercing hole 162, whereas the first rod 131 is placed in the first piercing hole 161 and pierces through the second rod 132; a slit 163, formed between the first rod 131 and the first piercing hole 161, enables the first rod 131 to be extended to adjust the height of the supporting frame 10 for work light. Thus when fixating the first rod 131 and the second rod 132, the cam structure 171, via the working of the movable rod 17, is to force the first rod 131 to lean toward the inner side of the main body 16 and the second rod 132 until it is totally fixated, further fixating the first rod 131 and the second rod 132.

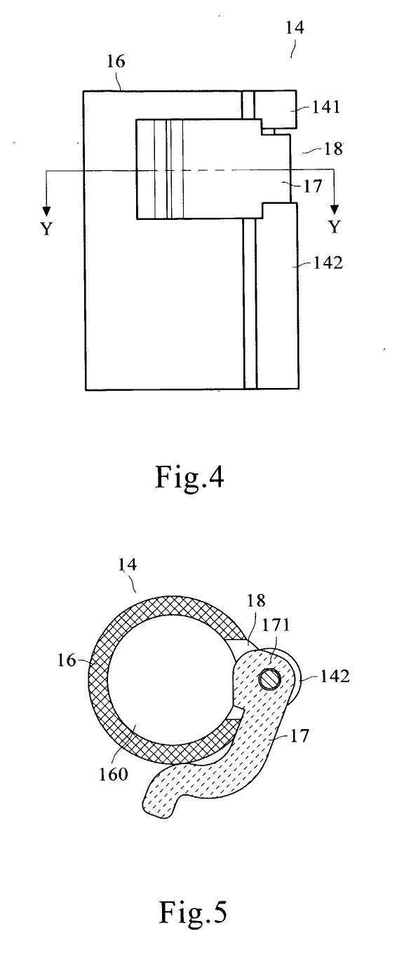

Please refer to FIG. 7, which shows a sectional view of the fixating mechanism coordinating with the extension rod having state of tightness from the Y-Y line in FIG. 4; at this time the movable rod 17 is under state of drawing back, wherein the first rod 131 located in the first piercing hole 161, for accepting the working of the moving rod 17, causes the protruding portion of the cam structure 171 to press the slit 163 between the first rod 131 and the first piercing hole 161, and thus causes the first rod 131 to tightly lean against one side of the first piercing hole 161 by the pressing of the cam structure 171.

Please refer to FIG. 8, which shows a sectional view of the fixating mechanism coordinating with the extension rod having state of looseness from the Y-Y line in FIG. 4; at this time the movable rod 17 is under state of release; since the movable rod 17 is released, the cam structure 171 of the movable rod 17 is to be placed in the notched groove 18 formed by the protruding portion 141 of the first piercing hole 161 and the protruding portion 142 of the second piercing hole 162.

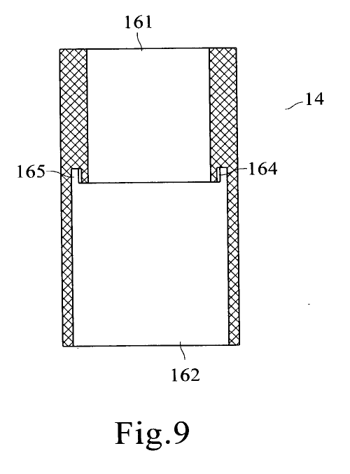

FIG. 9 shows another embodiment of the invention, displaying a sectional view of the fixating mechanism coordinating with the extension rod from the X-X line in FIG. 2, wherein the second piercing hole 162 extends upwards to be installed with a concave ring 165 and a plurality of protruding ribs 164 are formed on one side of the concave ring 165; please also refer to FIG. 6, when the second rod 132 is insertingly placed in the second piercing hole 162 toward the direction of the concave ring 165, the second rod 132 is not to be easily turned loose by the pressing of the protruding ribs 164.

The fixating mechanism 14 of the invention can not only be implemented in a set of extending rods (namely, the first rod 131 and the second rod 132), but it can also be implemented in the supporting frame 15. Furthermore, for the supporting frame 10 for work light to be applied on flat ground or adaptable to uneven surface, one of the feet in the supporting frame 15 can be designed to contain at least two extension rods (similar to the first rod 131 and the second rod 132, but only with shorter lengths), whereon the fixating mechanism 14 of the invention is installed, so that by adjusting the extension rods from a foot in the supporting frame 15, such foot with the fixating mechanism can compensate for the unevenness of any surface and sustain the standing stability of the supporting frame for work light.

What is claimed is:

1. A supporting frame for work light used for installing work light, comprising a set of extension rods, a fixating mechanism and a supporting frame; said supporting frame is pivotally jointed to said extension rods; the state of extension of said extension rods is to be fixated by said fixating mechanism; said fixating mechanism, installed at the junction of said extension rods, includes a main body having notched groove and a movable rod; said movable rod, operated with single action, controls the state of extension by the cam structure installed therein ,thus further enabling said fixating mechanism to secure or release the extension state of said extension rod.

2. A supporting frame for work light as in claim 1, wherein said extension rods includes at least a first rod and a second rod, and the junction of both said first and second rod is installed with said fixating mechanism so that the state of extension for two said rods is to be controlled.

3. A supporting frame for work light as in claim 1, wherein said main body includes round holes having same axis but different diameters, said round holes include a first and second piercing holes, with each said piercing hole extending to form two protruding portions respectively.

4. A supporting frame for work light as in claim 1, wherein said first piercing hole is used for being pierced through by another extension rod.

5. A supporting frame for work light as in claim 1, wherein said second piercing hole is used for being pierced through by another extension rod.

6. A supporting frame for work light as in claim 1, wherein said notched groove of said main body is formed by said protruding portion of said first piercing hole and said protruding portion of said second piercing hole.

7. A supporting frame for work light as in claim 3, wherein said second piercing hole extends upwards to be installed with a concave ring, and on one side of said concave ring a plurality of protruding ribs is formed.

8. A supporting frame for work light as in claim 1, wherein at least one foot in said supporting frame is installed with a set of extension rods, and the state of extension of said set of extension rods is to be adjusted by a fixating mechanism.
